(19) United States
(12) Patent Application Publication
(10) Pub. No.: US 2018/0256428 A1
(43) Pub. Date: Sep. 13, 2018

(54) HIP POSITIONER SYSTEM AND ARM ASSEMBLY

(71) Applicant: Innovative Medical Products, Inc., Plainville, CT (US)

(72) Inventor: Tim BLACKWELL, Plainville, CT (US)

(73) Assignee: Innovative Medical Products, Inc., Plainville, CT (US)

(21) Appl. No.: 15/920,445

(22) Filed: Mar. 13, 2018

Related U.S. Application Data
(60) Provisional application No. 62/470,867, filed on Mar. 13, 2017.

(51) Int. Cl. A61G 13/00; A61G 13/10; A61G 13/12

(52) U.S. Cl. CPC A61G 13/0081; A61G 13/123; A61G 13/1225; A61G 13/101

(57) ABSTRACT

The present invention relates to a positioner apparatus, system and method for supporting the body of a patient for a surgical procedure using a posterior pelvic support assembly in the area of the back, sacrum, coccyx, and/or the axial skeleton for the pelvic region of the spine, and an anterior pelvic support assembly for supporting the body at each of the crest of ilium area and the pubis area. The positioner system provides posterior and anterior pelvic support assemblies that are movably adjustable for freedom of movement in multiple coordinate planes to accommodate a wide range of patient sizes for surgery, e.g. where a patient is placed in the lateral decubitus position.

This application claims the benefit of U.S. provisional patent application No. 62/470,867 filed Mar. 13, 2107, the entirety of which is incorporated herein

### FIELD OF THE INVENTION

The present invention relates to a positioner apparatus, system and method in particular a system and method for supporting the pelvic skeleton for a surgical procedure using (1) a posterior pelvic support assembly (i.e., in the area of the back, sacrum, and coccyx, which are part of the axial skeleton for the pelvic region of the spine) and (2) an anterior pelvic support assembly for each of the (a) crest of ilium area and (b) pubis area. Both posterior and anterior pelvic support assemblies are movably adjustable in the vertical and horizontal plane (e.g. x, y and z coordinates) to accommodate a wide range of patient sizes for surgery, e.g. where a patient is placed in the lateral decubitus position.

### BACKGROUND OF THE INVENTION

Conventional positioner systems generally provide the support for the patient when undergoing a predetermined surgical procedure such as, for example, robotic laparoscopic surgeries and/or a hip replacement surgery. Modern hip replacement surgeries use imaging and robotic equipment that require a firm immobilization of the patient. Conventional hip positioner support assemblies can slip and reposition the body of the patient that has adverse effects to the surgical procedure and health of the patient. Moreover, conventional hip positioners have assemblies that obstruct the surgical area to robotic arms and imaging devices such as, for example, bars, plates and extensions that restrict access to the surgical area. As a result, there are problems with conventional support systems when using laparoscopic and other robotic surgical techniques. Consequently, there is a need for an improved support system for supporting a patient in a particular position that provides increased ability of the patient and improved access for the particular procedure including robotic and advanced laparoscopic procedures.

### SUMMARY OF THE INVENTION

It is an object of the present invention to provide an apparatus, system and method for use in supporting the pelvic skeleton for a surgical procedure to accommodate a wide range of patient sizes and in a variety of lateral positions. The positioning system further provides advantageously improved access for imaging, alignment sensors, and/or robotic equipment.

Another object of the present invention is to provide a posterior pelvic support for supporting the lumbar area and/or sacrum pelvic area.

A further object of the present invention to provide an anterior pelvic support utilizing the three points of: an inferior iliac crest, a superior iliac crest, and a pubis synthesis as anatomical landmarks for positioning these using arms and support pads secured to the OR table side rail. Another aspect of the present invention uses an arm extension to support the superior iliac crest positioned to provide an ascending arm for supporting the superior iliac crest.

It is yet another object to provide a system and method for supporting the patient utilizing improved positioning pads having axial deflection to conform to the surface of the patient's body at the points applied thereto.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 is a schematic, perspective view illustrating a positioner apparatus, system and method according to the present invention;

FIG. 2 is a schematic, perspective view of the anterior pelvic support assembly according to the present invention;

FIG. 3A is a schematic, perspective view of a positioning shaft, and FIG. 3B is a cross sectional view illustrating the positioning shaft of the positioning system and method according to the present invention;

FIGS. 4A and 4B are end views of the patient pelvis oriented in the positioning system and method according to the present invention;

FIGS. 5A and 5B are posterior and anterior pelvic views, respectively, of the patient pelvis oriented in the positioning system and method according to the present invention;

FIG. 6 is a top, superior view the patient pelvis oriented in the positioning system and method according to the present invention; and

FIG. 7A is a perspective view, and FIG. 7B is a cross sectional view of a socket assembly of the positioning system and method according to the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e. one or more methods, devices, or apparatuses for achieving the desired function and that one skilled in the art could select from these or their equivalent in view of the disclosure herein and use of the term “means” is not intended to be limiting.

As used herein the term “crest of the ilium” “crest of iliac” and/or “iliac crest” refers to the superior border of the wing of ilium and the superolateral margin of the greater pelvis. The iliac crest stretches posteriorly from the anterior superior iliac spine (ASIS) to the posterior superior iliac spine (PSIS), and stretches anteriorly from the anterior inferior iliac crest (AIIS) to the posterior inferior iliac crest (PIIS).

As used herein the term “posterior pelvic” refers to a posterior pelvic structures and area of the human anatomy of the sacrum (i.e. a large, triangular bone at the base of the spine), the lumbar area and/or sacrum pelvic area (e.g. the area between iliac crests of the posterior superior iliac spine (PSIS) and the posterior inferior iliac crest (PIIS)).

As used herein the term “pubic symphysis” and/or “symphysis pubis” refers to the midline cartilaginous joint (secondary cartilaginous) uniting the superior rami of the left and right pubic bones. The width of the pubic symphysis at the front is 3-5 mm greater than its width at the back. The ends of both pubic bones are covered by a thin layer of hyaline cartilage attached to the fibrocartilage.

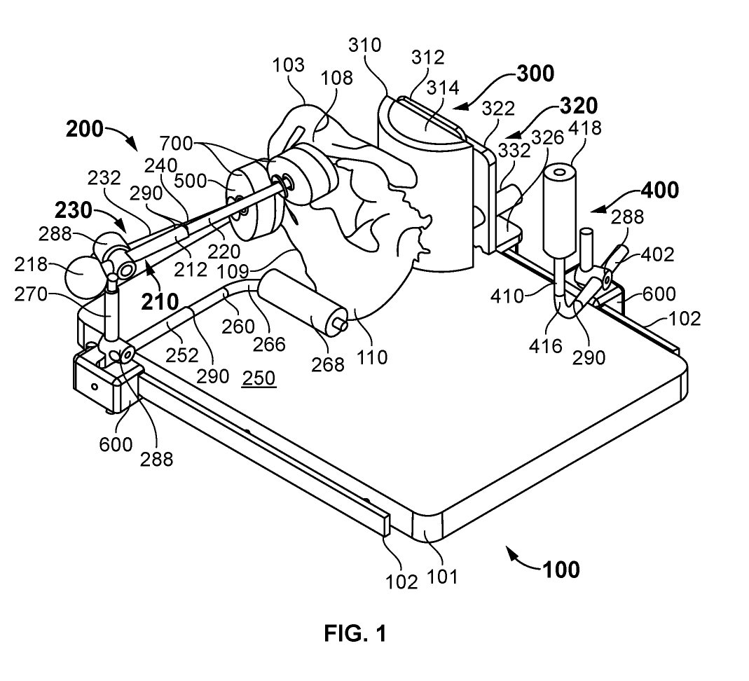

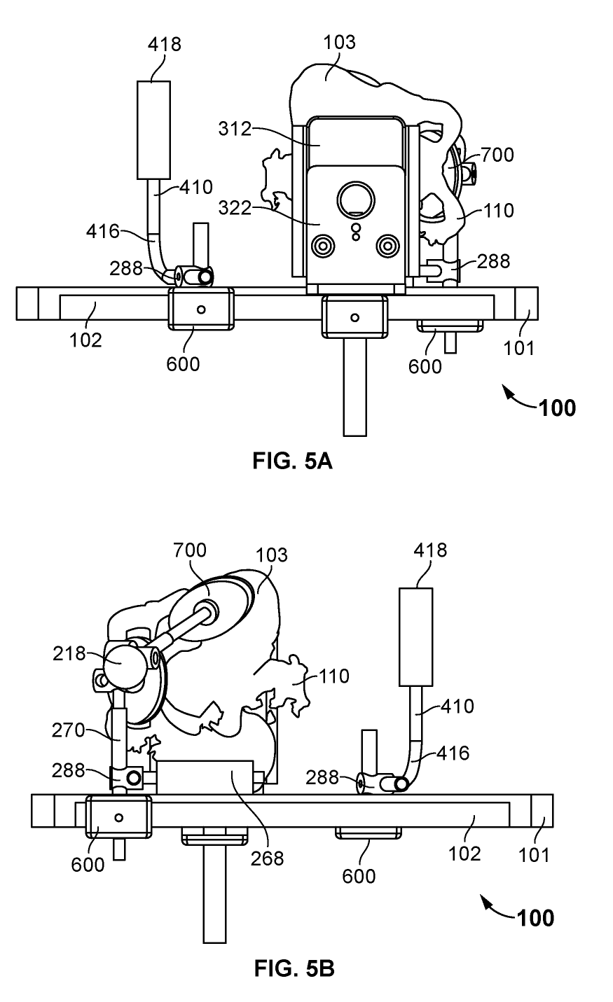

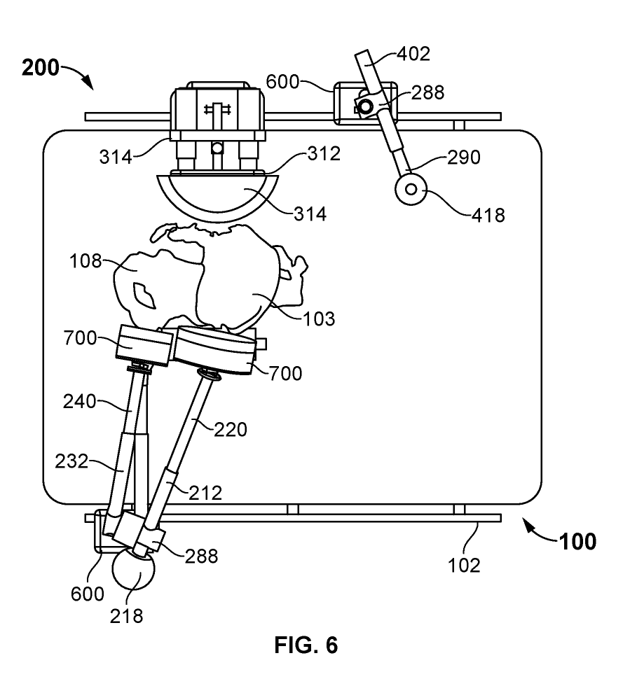

As is illustrated in FIGS. 1 through 7A-7B, a positioner apparatus, system and method for positioning a patient for surgical procedure is generally shown as element 100. The positioner system 100 may be configured for use with an operating room support table 101 (herein OR table) can be connected to the side rail 102 of the OR table 101. The position system 100 is described in relation to positioning the patient for the surgical procedure of a hip surgery. In operation, the positioner system 100 functions to stabilize the anatomy of the patient including the pelvic skeleton 104, posterior pelvic area 105 and sacrum 106, the anterior pelvic area 107 including the superior iliac crest 108, the pubis synthesis 109, and the inferior iliac crest 110 when positioning and supporting the patient for the surgical procedure. It should be appreciated by one skilled in the field the positioner system 100 may be used generally for positioning a patient for other surgical procedures and examinations.

Referring to FIG. 1, the positioner system 100 comprises an anterior pelvic support assembly 200, a posterior pelvic support assembly 300, a back support assembly 400, a socket pad assembly 500, and mounting clamp assemblies 600. The anterior pelvic support assembly 200 comprises a first support assembly 210 for supporting the superior iliac crest 108, a second support assembly 230 for supporting the pubis synthesis 109, and third support assembly 250 for supporting the inferior iliac crest 110. The first, second and third support assemblies 210, 230, 250 may be manufactured from suitable materials such as surgical grade stainless steel, aluminum, metals and/or metal alloys that our durable to withstand sterilization and use in the operating room for surgical procedures.

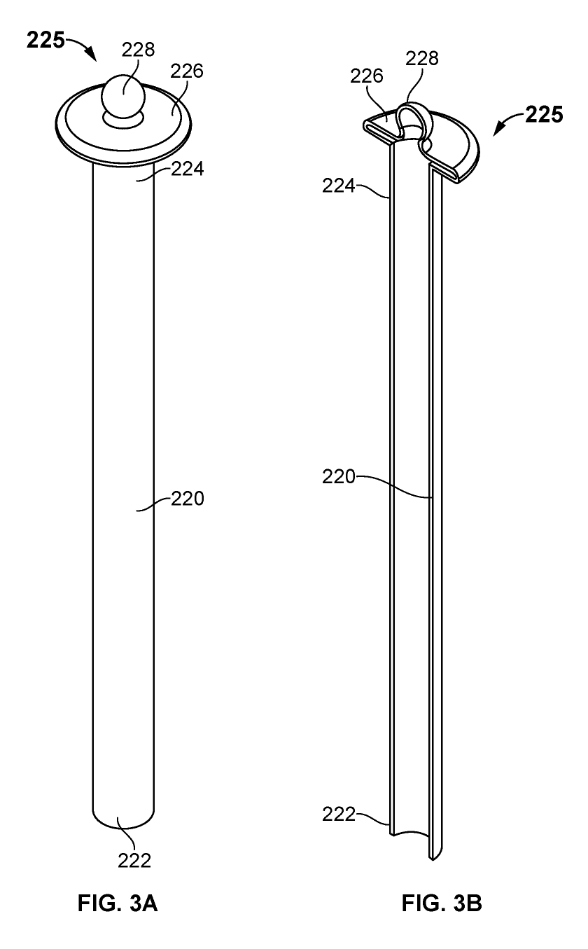

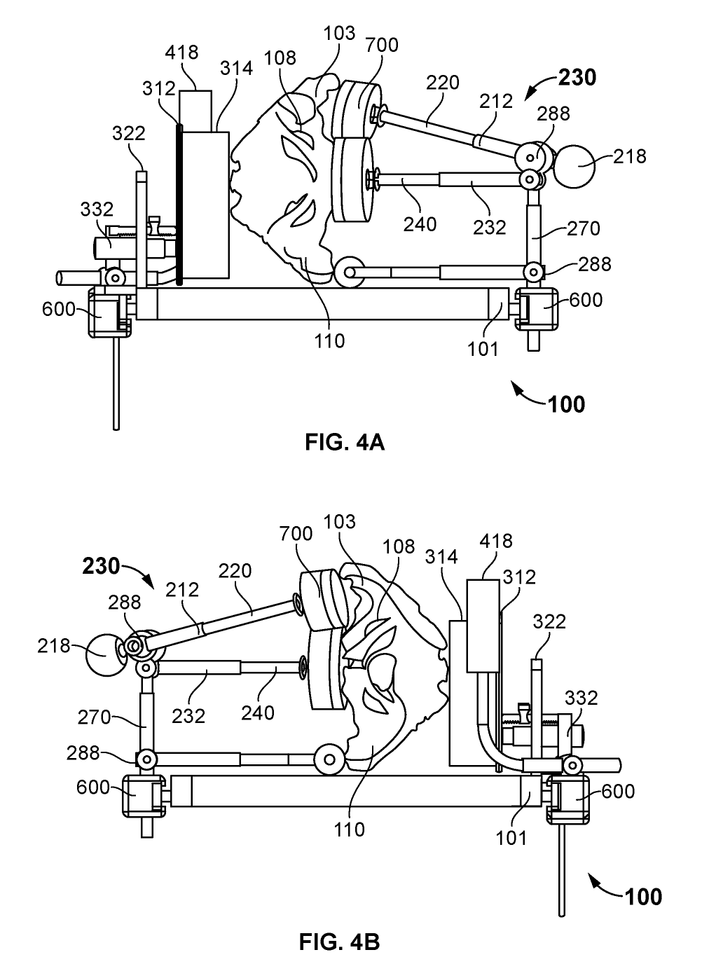

Referring to FIG. 1, and the views of FIGS. 4A-4B, 5A-5B and 6, the first support assembly 210 comprises a base shaft 212, a positioning shaft 220, and a camshaft lock 290, supporting the body of the patient whereby the base and positioning shafts 212, 220 may be formed or otherwise configured in an oval shape to accomplish the cam-shaft offset lock 290 as described herein. The base shaft 212 may be formed elongated generally rounded tubing and configured with a proximal end 214 and a distal end 216. Similarly, the positioning shaft 220 comprises a proximal end 222 and a distal end 224 with the distal end including a connection portion 225, a flange 226 and a pad ball connector 228 for connecting to a socket pad assembly 500, in particular, to the socket 520 formed in the base pad 510 thereof as shown in FIGS. 3A and 3B. The positioning shafts 240 on second support assembly 230 may be similarly constructed as shown in FIGS. 3A and 3B. The positioning shafts 220, 240 and 260 may have concentrically out of round tubing so as to provide a cam locking effect to set the positioning shafts 220, 240, 260 and 410, in the respective base shafts 212, 232, 252, and 402. The distal end 216 of the base shaft 212 may be configured with a bulbous handle 218 useful in positioning and establishing an ascending angle of the first support assembly 210 against the superior iliac crest 108. The distal end 216 of the base shaft 212 is configured is to receive the proximal end 222 of the positioning shaft 220 therein. In operation, the length of the operably coupled base shaft 212 and positioning shaft 220 may be shortened or extended as desired with the camshaft lock 290 being engaged by turning the positioning shaft 220 relative to the base shaft 212, e.g. twisting clock-wise or counter-clockwise. The distal end 224 of the positioning shaft 220 may be configured with a connection portion 225 comprising flange portion 226 supporting pad ball connector 228 functioning to operably connect a socket pad assembly 500 thereto for disposing against and supporting the patient in a surgical procedure.

Referring to FIG. 1, and the views of FIGS. 4A-4B, 5A-5B and 6, the second support assembly 230 comprises a base shaft 232, a positioning shaft 240, and a camshaft lock 290, supporting the body of the patient whereby the base and positioning shafts 232, 240 may be formed or otherwise configured in an oval shape to accomplish the cam-shaft offset lock 290 as described herein. The base shaft 232 may be formed elongated generally rounded tubing and configured with a proximal end 234 and a distal end 236. Similarly, the positioning shaft 240 comprises a proximal end 242 and a distal end 244. The distal end 234 of the base shaft 232 may be useful in positioning and for supporting of the second support assembly 230 against the pubis synthesis 109. The distal end 236 of the base shaft 232 is configured is to receive the proximal end 242 of the positioning shaft 240 therein. In operation, the length of the operably coupled base shaft 232 and positioning shaft 240 may be shortened or extended as desired with the camshaft lock 290 being engaged by turning the positioning shaft 240 relative to the base shaft 232, e.g. twisting clock-wise or counter-clockwise. The distal end 244 of the positioning shaft 240 may be configured with a connection portion 245 comprising flange portion 246 supporting pad ball connector 248 functioning to operably connect a socket pad assembly 500 thereto for disposing against and supporting the patient in a surgical procedure.

Referring to FIG. 1, and the views of FIGS. 4A-4B, 5A-5B and 6, the third support assembly 250 comprises a base shaft 252, a positioning shaft 260, and a camshaft lock 290, supporting the body of the patient whereby the base shaft 252 and positioning shaft 260 may be formed or otherwise configured in an oval shape to accomplish the cam-shaft offset lock 290 as described herein. The base shaft 252 may be formed elongated generally rounded tubing and configured with a proximal end 254 and a distal end 256. Similarly, the positioning shaft 260 comprises a proximal end 262 and a distal end 264. The distal end 256 of the base shaft 252 may be useful in positioning and for supporting of the third support assembly 250 against the inferior iliac crest 110. The distal end 256 of the base shaft 252 is configured to receive the proximal end 262 of the positioning shaft 260 therein. In operation, the length of the operably coupled base shaft 252 and positioning shaft 260 may be shortened or extended as desired with the camshaft lock 290 being engaged by turning the positioning shaft 260 relative to the base shaft 232, e.g. twisting clock-wise or counter-clockwise. The distal end 264 of the positioning shaft 260 may be configured with a bend or an arcuate portion 266 functioning to operably connect a roller pad to 268 thereto for disposing against and supporting the patient in a surgical procedure. The arcuate portion 266 may be formed in a range of angles between 45° and 90°, preferably, at approximately a right angle or 90 degrees.

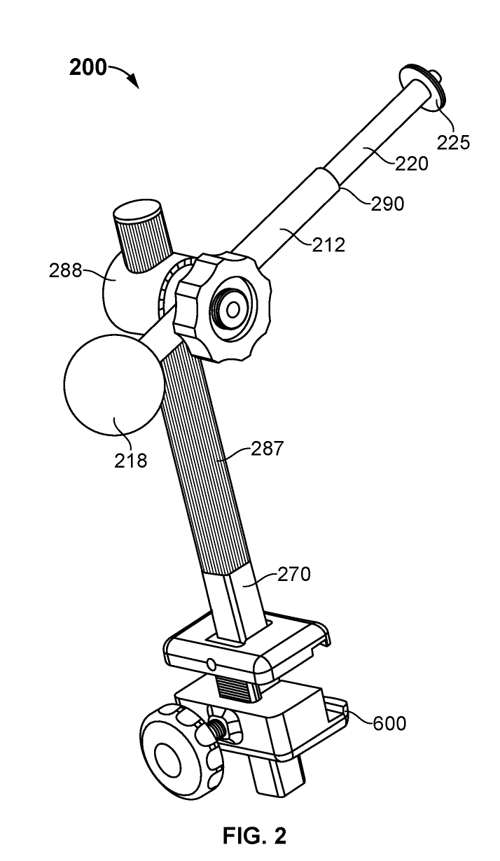

Referring to FIGS. 1 and 2, the first, second, and third support assemblies 210, 230, and 250, respectively may be supported and held by two or more connector sockets 288 to a rail support 270 to the rail mounting clamp 600. The rail support 270 includes a shaft 287 that may include grooves on a portion thereof for securing the sockets 288 thereto by a fastener assembly that may include a knob, handle or other means for turning to tighten or loosen to the shaft 287 of the rail support 270, as is illustrated in the views of FIGS. 4A-4B, 5A-5B and 6.

Referring to FIG. 1, the back support assembly 400 comprises a base shaft 402, a positioning shaft 410, and a camshaft lock 290, whereby the base and positioning shafts 402, 410 may be formed or otherwise configured in an oval shape to accomplish the cam-shaft offset lock 290 as described herein. The base shaft 402 may be formed elongated generally rounded tubing and configured with a proximal end 404 and a distal end 406. Similarly, the positioning shaft 410 comprises a proximal end 412 and a distal end 414. The distal end 406 of the base shaft 402 may be useful in positioning and for supporting of the back support assembly 400 against the posterior of the patient, e.g. mid-back. The distal end 406 of the base shaft 402 is configured to receive the proximal end 412 of the positioning shaft 410 therein. In operation, the length of the operably coupled base shaft 402 and positioning shaft 410 may be shortened or extended as desired with the camshaft lock 290 being engaged by turning the positioning shaft 410 relative to the base shaft 402, e.g. twisting clock-wise or counter-clockwise. The distal end 414 of the positioning shaft 410 may be configured with a bend or an arcuate portion 416 functioning to operably connect a roller pad to 418 thereto for disposing against and supporting the patient in a surgical procedure. The arcuate portion 416 may be formed in a range of angles between 45° and 90°, preferably, at approximately a right angle or 90 degrees.

Referring to FIG. 1, the positioner system 100 comprises a posterior pelvic support assembly 300 configured with a lumbar plate assembly 310 having a back plate 312 operatively connected to a rounded lumbar pad 314 made adjustable through an operable connection with an adjustment assembly 320. The adjustment assembly 320 comprises a rail bracket 322 configured as an upward extending plate 324, transverse plate 326 connected to the upward extending plate 324, and a rail shaft 328 connected to the transverse plate 326 for connecting with the clamp 604 for engaging the side rail 102. The adjustment assembly 320 further comprises a positioning arm assembly 330 configured with a base arm 332, a base arm 334, an inner arm 336, an inner arm 338, a locking shaft 340 that may include keyed adjacent slots 342 and a locking and release assembly 350. The adjustment assembly 320 is configured to slidably move the lumbar plate assembly 310 in a generally longitudinal direction, e.g. forward and reverse, so as to position the rounded lumbar pad 314 against the posterior pelvic area 105 and sacrum 106 of the patient undergoing a surgical procedure.

Referring to FIG. 1, the base arms 332, 334 and inner arms 336, 338 may be formed from tubing suitable materials such as surgical grade stainless steel, aluminum, metals and/or metal alloys that our durable to withstand sterilization and use in the operating room for surgical procedures. The base arms 332, 334 may be formed in a dimension having a predetermined diameter that is larger than the diameter of the inner arms 336, 338 so as to receive and operably coupled the inner arms 336, 338 in the base arms 332, 334 in a sliding relationship.

The locking and release assembly 350 generally includes a housing 352 configured to receive a push post 354 and biasing element 356 such as, for example, a spring. The push post 354 may be disposed adjacent the adjustment shaft 340, in particular, adjacent the keyed slots 342 so as to operatively engage or disconnect an edge 355 of the push post 354 from the one or more slot portions 342. The locking and release assembly 350 is configured to set and hold the lumbar pad assembly 310 in the desired position for the rounded lumbar pad 314 against the posterior pelvic area 105 and sacrum 106 of the patient undergoing a surgical procedure.

The back plate 312, transverse plate 326, and rail shaft 328 may be formed from suitable materials such as surgical grade stainless steel, aluminum, metals and/or metal alloys that our durable to withstand sterilization and use in the operating room for surgical procedures. The back plate 312 is configured with an opening 315 for the adjustment shaft 340 and locking and release assembly 350. Similarly, the back plate 312 is configured with an opening 316 receiving the base arm 332, and an opening 318 for receiving the base arm 334, whereby the base arms 332, 334 are secured to the back plate 312 with the inner arms 336, 338 articulating within the base arms 332, 334, respectively, to slidably move the lumbar plate assembly 310 in a generally longitudinal direction, e.g. forward and reverse, so as to position the rounded lumbar pad 314 against the posterior pelvic area 105 and sacrum 106 of the patient undergoing a surgical procedure.

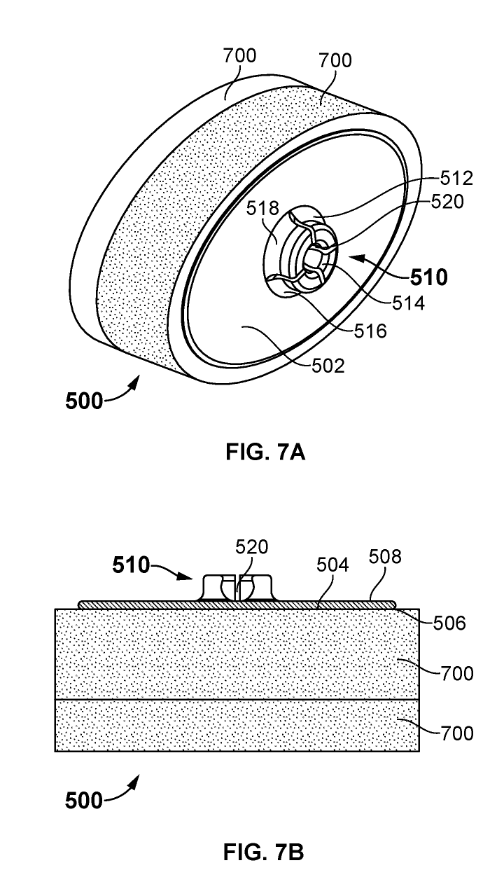

Referring to FIG. 7, the socket pad assembly 500 comprises a base support 502 with a top surface 504, bottom surface 506, and an edge 508. The top surface 504 is configured to operably connect to the ball connectors 228, 248. The bottom surface 506 is configured to connect to a pad assembly 700 by suitable adhesions and fastening methods. The base support 510 may be formed in any shape round, square, oval and is preferably oval or ellipse shape, and may be manufactured from suitable materials such as plastics and/or metals that may be sterilized and withstand the operating room environment. The base support 502 comprises a protrusion 510 and a socket 520 formed on the top surface 504 of the base support 502. The protrusion 510 may be configured in a plurality of protrusions 512, 514, 516, and 518 by operation of relief cuts 522 in 524 functioning to allow deflection of the protrusions 512, 514, 516, and 518 upon insertion of the ball connectors 228, 248. In this manner, the protrusions 512, 514, 516, and 518 are configured to operably connect the socket 520 to the ball connectors 228, 248 and advantageously provide multi-dimensional movement of the pad 700 resulting in comfort to the patient and improved stability of the supporting by the interior pelvic support assembly 200 of the hip positioner system 100.

Referring to FIG. 1, the mounting clamp assembly 600 comprises a clamp body 610 configured with an enclosure 612 having an upper rail arm 614, a lower rail arm 616, and a real guide portion 618. The mounting clamp assembly 600 further includes a clamp fastener assembly 620 comprising a knob 622 disposed on a threaded shaft 624 that is connected to a pressure plate 626 arranged within the enclosure 612 of the clamp body 610, whereby tightening the knob 622 connected to the threaded shaft 624, e.g. clock-wise or counter-clockwise, forces the pressure plate 626 against the side rail 102 of the OR table 101. The enclosure 612 may be formed with an aperture 628 configured to receive an arm, post, bar, or other structure for within the aperture 628 so as to mount and hold the anterior pelvic support assembly 200, the posterior pelvic support assembly 300, and the back positioner assembly 400 to the side rail 102 of the OR table.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A positioner system for positioning a patient for surgical procedure connected to a side rail on a support table, said positioner system comprising:
an anterior pelvic support assembly comprising a first support assembly for supporting a superior iliac crest, a second support assembly for supporting a pubis synthesis, and third support assembly for supporting an inferior iliac crest;
a posterior pelvic support assembly comprising a lumbar plate assembly having a back plate operatively connected to a lumbar pad made adjustable through an operable connection with an adjustment assembly;
a back support assembly comprises a base shaft, a positioning shaft, and a camshaft offset lock, whereby said base shaft and said positioning shaft may be configured in an oval shape for securing with an offset of a camshaft lock in a position for positioning a distal end of said base shaft to support said back support assembly against a posterior of the patient; and
one or more mounting of a clamp assembly comprising an enclosure configured with an aperture for receiving a structure therein for securing each of said anterior pelvic support assembly, said posterior pelvic support assembly, and said back support assembly to the side rail of the support table.

2. The positioner system of claim 1, wherein said adjustment assembly comprises a rail bracket configured as an upward extending plate, a transverse plate connected to said plate, and a rail shaft connected to said transverse plate for connecting with a mounting clamp for engaging the side rail.

3. The positioner system of claim 2, wherein said adjustment assembly further comprises a positioning arm assembly configured with one or more of a base arm, one or more of an inner arm, and a locking shaft.

4. The positioner system of claim 3, wherein said locking shaft comprises a keyed adjacent slots and a locking and release assembly.

5. The positioner system of claim 1 wherein said adjustment assembly further comprises said back plate configured with an opening receiving a base arm secured to said back plate with an inner arm articulating within said base arm to slidably move the lumbar plate assembly in a generally longitudinal direction, forward and reverse, in a desired position a rounded lumbar pad against a posterior pelvic area and a sacrum of the patient undergoing the surgical procedure.

6. The positioner system of claim 5, wherein said distal end of said positioning shaft is configured with an arcuate portion for operably connecting a roller pad disposed thereon for supporting the patient in the surgical procedure.

7. The positioner system of claim 1, further comprising a locking and release assembly configured with a housing adapted to receive a push post and biasing element therein, whereby said push post may be disposed adjacent one or more slot portions of an adjustment shaft to operatively engage or disconnect an edge of said push post from one of said one or more slot portions.

8. The positioner system of claim 1, further comprising a socket pad assembly for connecting to a distal portion of said positioning shaft.

9. The positioner system of claim 8, wherein said positioning shaft comprises a proximal end and a distal end configured with a connection portion, a flange, and a pad ball connector for connecting to a socket formed in a base pad of said socket pad assembly.
